(19) United States
(12) Patent Application Publication
(10) Pub. No.: US 2012/0111269 A1
(43) Pub. Date: May 10, 2012

(54) VIEW PORT DEVICE FOR PLASMA PROCESS AND PROCESS OBSERVATION DEVICE OF PLASMA APPARATUS

(76) Inventors: Chen-Chung DU, Hsinchu City (TW); Muh-Wang Liang, Toufen Township (TW); Guan-Yu Lin, Puyan Township (TW); Ta-Chin Wei, Zhongli City (TW)

(21) Appl. No.: 13/009,526

(22) Filed: Jan. 19, 2011

(30) Foreign Application Priority Data
Nov. 5, 2010 (TW) 99138209

(51) Int. Cl. B05C 11/00

(52) U.S. Cl. 118/713

(57) ABSTRACT

A view port device for a plasma process and a process observation device of a plasma apparatus are provided. The view port device for a plasma process comprises a first substrate portion, a second substrate portion, and a connecting portion. The first substrate portion has a first through hole. The second substrate portion has a second through hole and a second diffusion space. A cross-sectional area of the second diffusion space is larger than that of the second through hole. The connecting portion is disposed between the first substrate portion and the second substrate portion.

This application claims the benefit of Taiwan application Serial No. 99138209, filed Nov. 5, 2010, the subject matter of which is incorporated herein by reference.

### BACKGROUND

1. Technical Field

The invention relates in general to a view port device, and more particularly to a plasma process observation device with a view port device.

2. Description of the Related Art

A plasma enhanced chemical vapor deposition process can be used for depositing and etching a film. A result of the depositing and etching the film is closely related to a concentration of active reaction species during the process. Therefore, it is very important to observe and analyze the change in the concentration among the active reaction species during the plasma process.

For example, a method for observing the plasma enhanced chemical vapor deposition process is using an optical emission spectroscopy (OES) for capturing the plasma spectral changes of the active reaction species inside the reaction chamber from outside the chamber through a view port glass to obtain the concentrations among the reaction species.

However, during the film deposition process, the active reaction species are deposited on not only substrate but also the view port glass. The film deposited on the view port glass would deteriorate the optical transmission of the view port glass and thus make the light radiated by the active reaction species inside the reaction chamber decay. It distorts the spectral analysis of the concentration of the active reaction species done by the OES. As the process time increase, the decay and distortion would get worse.

A general method for resolving the above problem is disposing a honeycomb structure shutter between the reaction chamber and the view port glass, and a introducing a gas flow between the honeycomb shutter and the view port glass to prevent the active reaction species inside the reaction chamber from being diffused onto the view port glass. Thus, the active reaction species would not be deposited on the view port glass.

However, the honeycomb structure shutter used in the said generally known technology is complicated and incurs high cost, and also requires the use of additional devices such as vacuum pipes, valves, and sealing device. Besides, the introduced gas flow may affect the stability in the current field inside the reaction chamber.

### SUMMARY

The disclosure is directed to a view port device for a plasma process and a process observation device of a plasma apparatus. The structure and manufacturing method for the view port device for a plasma process are simple and incur low cost, and the process observation device of a plasma apparatus can be formed with simple elements. The process observation device with a view port device reduces the amount of the active reaction deposition species being diffused to the view port glass from the reaction chamber during the plasma or the etching process, so that the level or rate at which the view port glass is polluted is low, and the view port glass still maintain excellent optical transmission during a long duration of reaction process.

According to a first aspect of the present disclosure, a view port device for a plasma process is provided. The view port device for a plasma process comprises a first substrate portion, a second substrate portion and a connecting portion. The first substrate portion has a first through hole. The second substrate portion has a second through hole and a second diffusion space. A cross-sectional area of the second diffusion space is larger than that of the second through hole. The connecting portion is disposed between the first substrate portion and the second substrate portion. The view port device for a plasma process is disposed between a reaction chamber of the plasma apparatus and the view port glass. The second diffusion space is adjacent to the view port glass. The first through hole is adjacent to the reaction chamber.

According to a second aspect of the present disclosure, a process observation device used in a plasma apparatus is provided. The process observation device of a plasma apparatus comprises a view port device and a view port glass. The view port device comprises a first substrate portion, a second substrate portion and a connecting portion. The first substrate portion has a first through hole. The second substrate portion has a second through hole and a second diffusion space. A cross-sectional area of the second diffusion space is larger than that of the second through hole. The first through hole, the second through hole and the second diffusion space are interconnected to form an observation path. The connecting portion is disposed between the first substrate portion and the second substrate portion. The view port device is disposed between a reaction chamber of the plasma apparatus and the view port glass. The second diffusion space is adjacent to the view port glass. The first through hole is adjacent to the reaction chamber.

According to a third aspect of the present disclosure, a view port device for a plasma process is provided. The view port device for a plasma process comprises a first substrate portion and a second substrate portion. The first substrate portion has a first through hole and a first diffusion space. A cross-sectional area of the first diffusion space is larger than that of the first through hole. The second substrate portion has a second through hole and a second diffusion space. A cross-sectional area of the second through hole is smaller than that of the first diffusion space. A cross-sectional area of the second diffusion space is larger than that of the second through hole. The first through hole, the first diffusion space, the second through hole and the second diffusion space are interconnected to form an observation path. The view port device for a plasma process is disposed between a reaction chamber of the plasma apparatus and the view port glass. The second diffusion space is adjacent to the view port glass. The first through hole is adjacent to the reaction chamber.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a 3-D perspective of a view port device of a first embodiment;

FIG. 2 shows a cross-sectional view of a plasma apparatus of the first embodiment;

FIG. 3 shows an enlargement view of the plasma apparatus of FIG. 2;

FIG. 4 shows test results of optical transmission of a view port quartz glass of one embodiment before and after a plasma enhanced chemical vapor deposition process;

FIG. 5 shows an enlargement view of a plasma apparatus of a second embodiment; and

FIG. 6 shows a 3-D perspective of a view port device of a third embodiment.

### DETAILED DESCRIPTION

The spirit of the invention is that the observation through hole of the plasma process view port has at least one diffusion space, and the active reaction species entering the observation through hole via the diffusion space are deposited on the surface of the diffusion space, so that the amount of the active reaction species deposited on the view port glass is reduced.

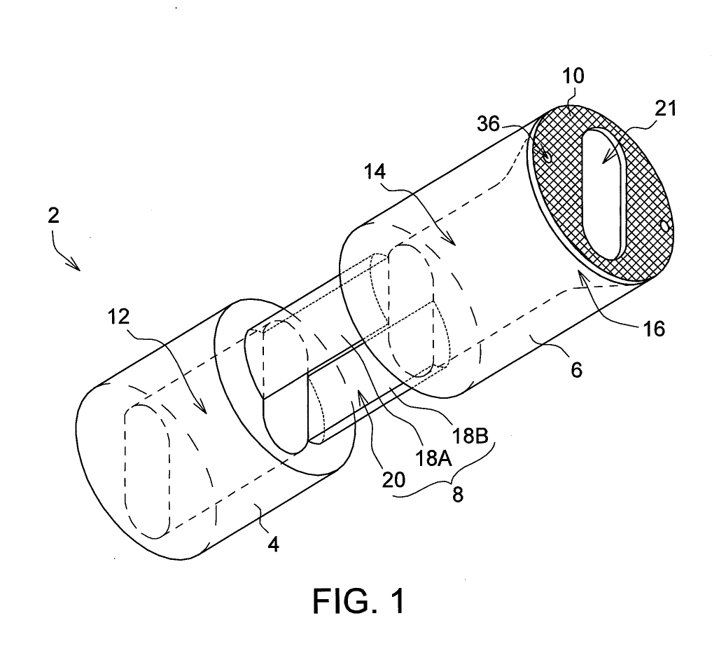

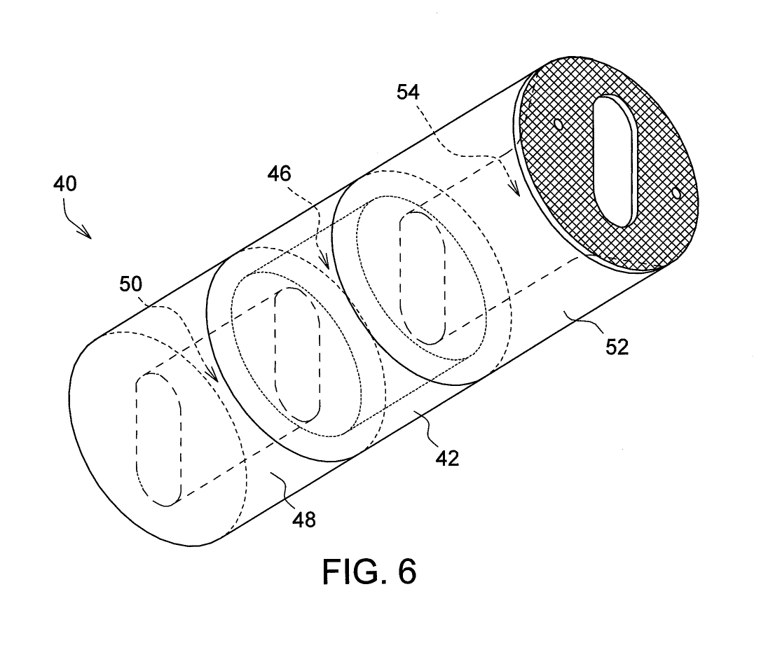

FIG. 1 shows a 3-D perspective of a view port device of a first embodiment. Referring to FIG. 1, the view port device 2 comprises a first substrate portion 4, a second substrate portion 6, a connecting portion 8 and a mesh element 10. The first substrate portion 4 has a first through hole 12. The second substrate portion 6 has a second through hole 14 and a second diffusion space 16. The mesh element 10 has an observation hole 21, and can be formed by a metal such as stainless mesh, aluminum mesh or titanium mesh. The mesh element 10 can be fixed on the second substrate portion 6 through a fixing pin 36. However, the invention is not limited thereto. In other embodiments, for example, the mesh element 10 can be embedded into the second substrate portion 6. The connecting portion 8 may comprise third substrate portions 18A and 18B and an opening 20 which is disposed between the third substrate portions 18A and 18B. However, the connecting portion 8 is not limited to the structure exemplified above, and can be realized by other structure with an opening. In other embodiments, for example, the connecting portion 8 may have only one of the third substrate portions 18A and 18B. In another embodiment, the first substrate portion 4, the second substrate portion 6, and the connecting portion 8 can be an integral one-piece structure as disclosed in the elaboration of FIG. 6. The structure and manufacturing method for the view port device 2 are simple and incur low cost.

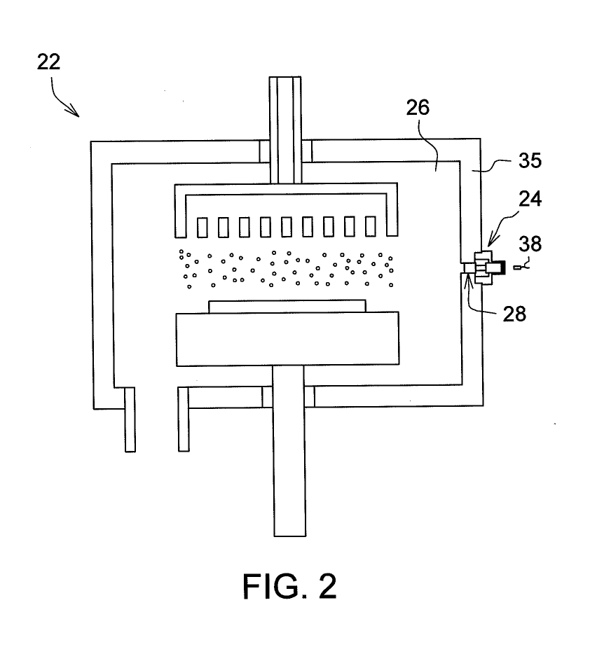

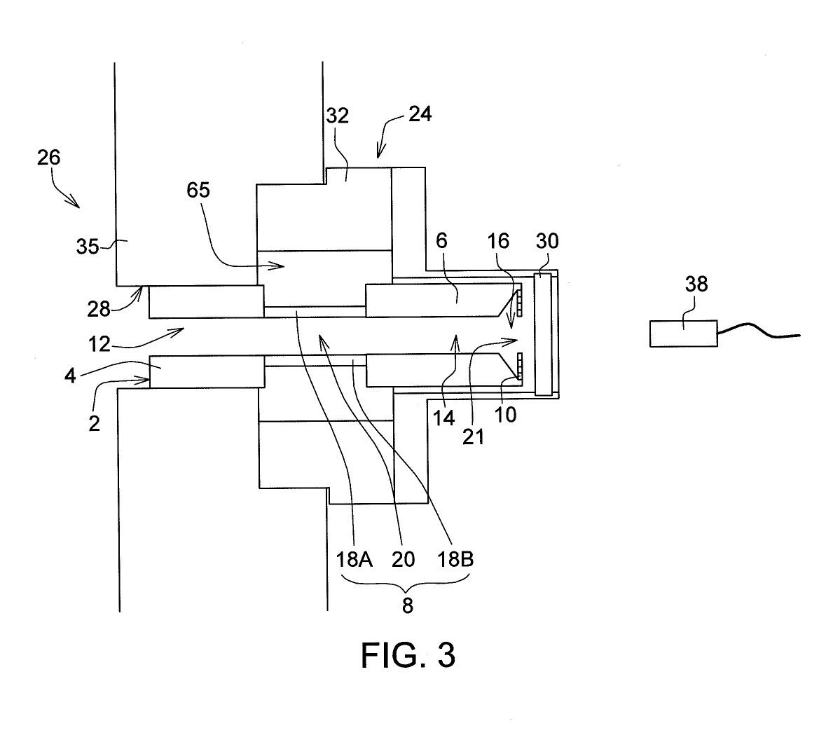

FIG. 2 shows a cross-sectional view of a plasma apparatus of the first embodiment. FIG. 3 shows an enlargement view of the plasma apparatus of FIG. 2. As indicated in FIG. 2, the plasma apparatus 22 can be realized by a plasma process apparatus such as a plasma enhanced chemical vapor deposition apparatus, but the invention is not limited thereto, and may comprise other plasma apparatuses. The plasma apparatus 22 may comprise a process observation device 24, a reaction chamber 26, a chamber wall 35 and an element disposition port 28. As indicated in FIG. 3, the process observation device 24 may comprise a view port glass 30, a hollowed connecting element 32 and the view port device 2 as illustrated in FIG. 1. The view port glass 30 can be realized by an ordinary transparent substrate such as quartz glass, etc. The view port device 2 can be disposed on the element disposition port 28 through the hollowed connecting element 32. The hollowed connecting element 32 forms a hollowed space which forms a first diffusion space 65 for the active reaction species with the opening 20 of the connecting portion 8. The first diffusion space 65 can be disposed between the first through hole 12 and the second through hole 14. The opening 20 interconnects the first diffusion space 65, the first through hole 12 and the second through hole 14.

As indicated in FIG. 3, the size of the first through hole 12 is far smaller than that of the reaction chamber 26, so the concentration of the active reaction species in the reaction chamber 26 would be diffused into the first through hole 12. The active reaction species in the first through hole 12 can be diffused into the first diffusion space 65 through the opening 20 of the connecting portion 8. Since a cross-sectional area of the first diffusion space 65 is larger than that of the first through hole 12, the active reaction deposition species diffused into the first diffusion space 65 are more likely to collide with the inner wall of the hollowed connecting element 32. As a result, most of the active reaction deposition species would be deposited on the inner wall of the hollowed connecting element 32, and the amount of the active reaction deposition species would be reduced. A cross-sectional area of the second through hole 14 is smaller than that of the first diffusion space 65. Therefore, only a small amount of remnant active reaction deposition species would be diffused into the second through hole 14 from the first diffusion space 65.

As indicated in FIG. 3, a cross-sectional area of the second diffusion space 16 is larger than that of the second through hole 14, so the active reaction species diffused into the second diffusion space 16 from the second through hole 14 would be spread out. In addition, the active reaction species inside the second diffusion space 16 are more likely to collide with the second substrate portion 6. As a result, the remnant active reaction deposition species would be deposited on the surface of the second substrate portion 6. Exemplarily, the cross-sectional area of the second diffusion space 16 extends gradually towards the view port glass 30 from the second through hole 14 (for example, the shape of the second diffusion space 16 is like a funnel) as indicated in FIG. 3, so that the active reaction species coming from the second through hole 14 can be smoothly diffused into the second diffusion space 16. In one embodiment, the angle contained between the sidewalls of the second diffusion space 16 and the second through hole 14 equals 120 degrees. However, the shape of the second diffusion space 16 is not limited to a funnel shape. In other embodiments, the second diffusion space 16 can be in other shapes to fit in actual needs. The mesh element 10 with a larger surface also enables the active reaction species to be deposited thereon.

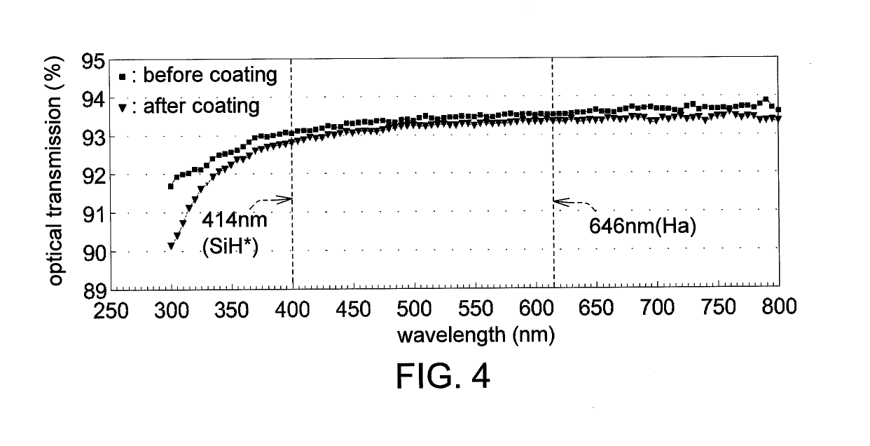

Thus, at the end, an amount of active reaction deposition species passing through the observation hole 21 of the mesh element 10 to be deposited on the view port glass 30 is very small. Thus, the level or rate at which the view port glass 30 is polluted is low, and the view port glass 30 can still maintain excellent optical transmission during a reaction process of a long duration. Thus, the decay in the strength of the light of the view port glass 30 is very low. For example, FIG. 4 shows test results of optical transmission of a view port quartz glass of one embodiment before and after a plasma enhanced chemical vapor deposition process. A microcrystalline silicon (μc-Si) film is formed by the plasma enhanced chemical vapor deposition process. The process duration is 40 minutes. As indicated in FIG. 4, after the plasma enhanced chemical vapor deposition process is completed, the optical transmission of the SiH* (the spectrum wavelength is 414 nm) and the Hα (the spectrum wavelength is 646 nm) active species of the view port quartz glass only decays by 0.3% which is very low. Such result shows that after a long duration of plasma coating process, the view port glass of the process observation device using the view port device of the invention still remain excellent optical transmission.

As indicated in FIG. 3, the plasma light radiated by the active reaction species in the reaction chamber 26 must pass through the first through hole 12, the first diffusion space 65, the second through hole 14, the second diffusion space 16, and the observation hole 21 so as to be sensed by the sensor 38 such as an optical emission spectroscopy (OES) sensor used in the plasma enhanced chemical vapor deposition process. Thus, the first through hole 12, the first diffusion space 65, the second through hole 14, the second diffusion space 16, and the observation hole 21 are exemplarily corresponded to each other. In other words, the first through hole 12, the first diffusion space 65, the second through hole 14, and the second diffusion space 16 are interconnected to form an observation path. In an embodiment, the first through hole 12, the second through hole 14 and observation hole 21 may have identical cross-sectional area, but the invention is not limited thereto.

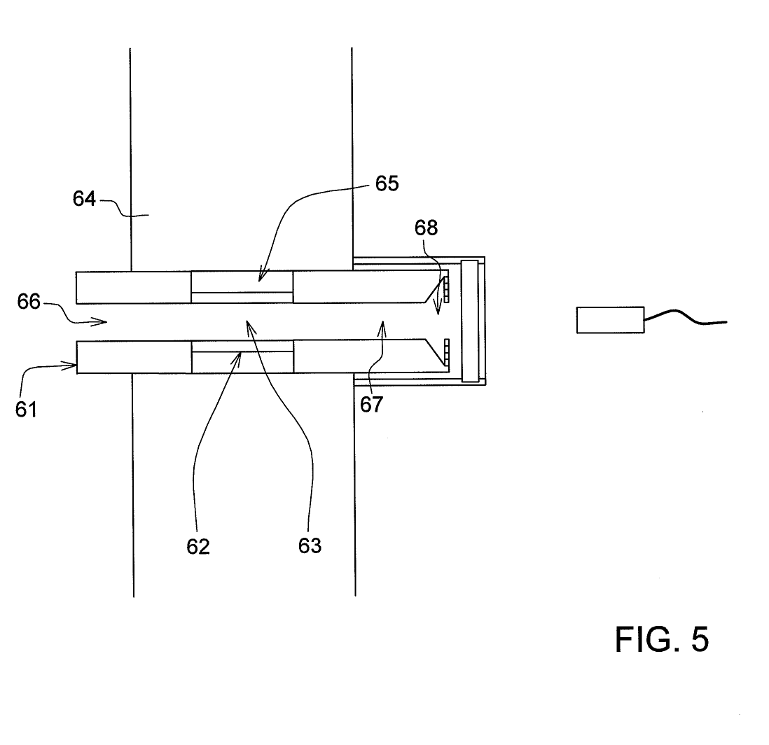

FIG. 5 shows an enlargement view of a plasma apparatus of a second embodiment. The plasma apparatus of FIG. 5 is different from the plasma apparatus of FIG. 3 in that the first diffusion space 65 is formed between the opening 63 of the connecting portion 62 of the view port device 61 and the chamber wall 64 of the plasma apparatus. The cross-sectional area of the first diffusion space 65 is larger than that of the first through hole 66 and is larger than that of the second through hole 67. The first through hole 66, the second through hole 67, the first diffusion space 65 and the second diffusion space 68 are interconnected to form an observation path.

FIG. 6 shows a 3-D perspective of a view port device of a third embodiment. The view port device 40 of FIG. 6 is different from the view port device 2 of FIG. 1 in that the first substrate portion 48, the second substrate portion 52 and the connecting portion 42 are an integral one-piece structure, and the connecting portion 42 has a first diffusion space 46 therein. The cross-sectional area of the first diffusion space 46 is larger than that of the first through hole 50 of the first substrate portion 48 and is larger than that of the second through hole 54 of the second substrate portion 52. The first substrate portion 48, the second substrate portion 52 and the connecting portion 42 can be an integral one-piece structure. The structure and manufacturing method for view port device 40 are simple and incur low cost.

In embodiments of the invention, the structure and manufacturing method for the view port device are simple and incur low cost, and the process observation device of a plasma apparatus can be formed with simple elements.

The size of the first through hole of the first substrate portion of the process observation device with the view port device is far smaller than that of the reaction chamber. The active reaction deposition species would be diffused into the first through hole. The cross-sectional area of the connecting through hole or first diffusion space of the connecting portion is larger than the cross-sectional area of the first through hole. Thus, the amount of the active reaction deposition species diffused into the connecting through hole or first diffusion space would be reduced since a greater part of the active reaction deposition species would be deposited on the surface of the first diffusion space. In addition, since the cross-sectional area of the second through hole of the second substrate portion is smaller than the cross-sectional area of the connecting through hole or first diffusion space, only a small amount of the active reaction species remnant in the connecting through hole or first diffusion space would be diffused into the second through hole. Moreover, since the cross-sectional area of the second diffusion space of the second substrate portion is larger than that of the second through hole, the active reaction species diffused into the second diffusion space would be further deposited on the surface of the second diffusion space and reduced accordingly. The mesh element adjacent to the view port glass enables the reaction species to be deposited on the mesh element.

Therefore, the process observation device with the view port device can reduce the amount of the active reaction deposition species being diffused onto the view port glass from the reaction chamber during the plasma process, so that the level or rate at which the view port glass is polluted is low, and the view port glass still maintain excellent optical transmission during the long duration of reaction process.

Since the first through hole, the second through hole, the second diffusion space, the observation hole and the connecting through hole (or the first diffusion space) are interconnected to form the observation path, the sensor can sense the plasma light radiated by the active reaction species from the reaction chamber.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A view port device for a plasma process, comprising:
a first substrate portion having a first through hole;
a second substrate portion having a second through hole and a second diffusion space, wherein a cross-sectional area of the second diffusion space is larger than that of the second through hole; and
a connecting portion disposed between the first substrate portion and the second substrate portion.

2. The view port device for a plasma process according to claim 1, wherein the view port device for a plasma process is disposed between a reaction chamber of a plasma apparatus and a view port glass, the second diffusion space is adjacent to the view port glass, and the first through hole is adjacent to the reaction chamber.

3. The view port device for a plasma process according to claim 2, wherein the plasma apparatus comprises a plasma enhanced chemical vapor deposition apparatus.

4. The view port device for a plasma process according to claim 2, further comprising a mesh element which has an observation hole and is disposed between the second diffusion space and the view port glass.

5. The view port device for a plasma process according to claim 2, wherein the cross-sectional area of the second diffusion space extends gradually towards the view port glass from the second through hole.

6. The view port device for a plasma process according to claim 1, wherein the connecting portion comprises a third substrate portion and an opening adjacent to the third substrate portion.

7. The view port device for a plasma process according to claim 1, wherein the first substrate portion, the second substrate portion and the connecting portion are an integral one-piece structure, the connecting portion has a first diffusion space therein, and a cross-sectional area of the first diffusion space is larger than a cross-sectional area of the first through hole and is larger than that of the second through hole.

8. A process observation device of a plasma apparatus, comprising:
a view port device, comprising:
a first substrate portion having a first through hole;
a second substrate portion having a second through hole and a second diffusion space, wherein a cross-sectional area of the second diffusion space is larger than that of the second through hole, and wherein the first through hole, the second through hole and the second diffusion space are interconnected to form an observation path; and
a connecting portion disposed between the first substrate portion and the second substrate portion; and
a view port glass,
wherein the view port device is disposed between a reaction chamber of a plasma apparatus and the view port glass, the second diffusion space is adjacent to the view port glass, and the first through hole is adjacent to the reaction chamber.

9. The process observation device of a plasma apparatus according to claim 8, wherein the plasma apparatus comprises a plasma enhanced chemical vapor deposition apparatus.

10. The process observation device of a plasma apparatus according to claim 8, further comprising a mesh element, which has an observation hole and is disposed between the second diffusion space and the view port glass.

11. The process observation device of a plasma apparatus according to claim 8, wherein the cross-sectional area of the second diffusion space extends gradually towards the view port glass from the second through hole.

12. The process observation device of a plasma apparatus according to claim 8, wherein the connecting portion comprises a third substrate portion and an opening adjacent to the third substrate portion.

13. The process observation device of a plasma apparatus according to claim 12, wherein the view port device is disposed in a chamber wall of the plasma apparatus, a first diffusion space is formed between the opening of the connecting portion and the chamber wall, a cross-sectional area of the first diffusion space is larger than that of the first through hole and is larger than that of the second through hole, and the first diffusion space, the first through hole, the second through hole and the second diffusion space are interconnected to form an observation path.

14. The process observation device of a plasma apparatus according to claim 12, further comprising a hollowed connecting element, wherein the view port device is disposed in the chamber wall of the plasma apparatus through the hollowed connecting element, a first diffusion space is formed between the opening of the connecting portion and the hollowed connecting element, a cross-sectional area of the first diffusion space is larger than that of the first through hole and is larger than that of the second through hole, and the first diffusion space, the first through hole, the second through hole and the second diffusion space are interconnected to form an observation path.

15. The process observation device of a plasma apparatus according to claim 8, wherein the first substrate portion, the second substrate portion and the connecting portion are an integral one-piece structure.

16. A view port device for a plasma process, comprising:
a first substrate portion having a first through hole and a first diffusion space, wherein a cross-sectional area of the first diffusion space is larger than that of the first through hole; and
a second substrate portion having a second through hole and a second diffusion space, wherein a cross-sectional area of the second through hole is smaller than that of the first diffusion space, a cross-sectional area of the second diffusion space is larger than that of the second through hole, and wherein the first through hole, the first diffusion space, the second through hole and the second diffusion space are interconnected to form an observation path;
wherein the view port device for a plasma process is disposed between a reaction chamber of a plasma apparatus and a view port glass, the second diffusion space is adjacent to the view port glass, and the first through hole is adjacent to the reaction chamber.
